(19) United States
(12) Patent Application Publication
(10) Pub. No.: US 2026/0360290 A1
(43) Pub. Date: Nov. 12, 2026

(54) PIXEL DRIVING CIRCUIT AND DRIVING METHOD THEREFOR, DISPLAY SUBSTRATE, AND DISPLAY APPARATUS

(71) Applicants: Yunnan Invensight Optoelectronics Technology Co., Ltd., Kunming, Yunnan (CN); BOE Technology Group Co., Ltd., Beijing (CN)

(72) Inventors: Jianguo FU, Beijing (CN); Shengji YANG, Beijing (CN); Junyan YANG, Beijing (CN); Bin WU, Beijing (CN); Shengdi ZHU, Beijing (CN); Yanqiang DING, Beijing (CN); Yun ZHU, Beijing (CN); Qibin CAI, Beijing (CN)

(21) Appl. No.: 18/860,017

(22) PCT Filed: Feb. 6, 2024
(86) PCT No.: PCT/CN2024/076339

§ 371 Date: Oct. 25, 2024

(30) Foreign Application Priority Data
Mar. 29, 2023 (CN) 202310325458.3

(51) Int. Cl. G09G 3/20; G09G 3/3233

(52) U.S. Cl. CPC G09G 3/2007; G09G 3/2092; G09G 3/3233; G09G 2300/0819; G09G 2300/0852; G09G 2300/0861; G09G 2310/08; G09G 2320/0242

(57) ABSTRACT

Disclosed is a pixel driving circuit, including: a current control sub-circuit, wherein the current control sub-circuit comprises a driving transistor, and the driving transistor is configured to provide a driving current to a light-emitting device according to a voltage between a gate electrode and a first electrode. The pixel driving circuit further comprises: a voltage control sub-circuit and a time control sub-circuit, wherein the voltage control sub-circuit is configured to transmit a time data signal to the time control sub-circuit in response to a time modulation signal; and the time control sub-circuit is configured to control a gate voltage of the driving transistor according to a voltage difference between a modulation voltage signal and a reference signal and a voltage difference between the time data signal and the reference signal, so as to control the light emission time of the light-emitting device.

### CROSS-REFERENCE TO RELATED APPLICATIONS

The present application is a U.S. National Phase Entry of International Application No. PCT/CN2024/076339 having an international filing date of Feb. 6, 2024, which claims priority to Chinese Patent Application No. 202310325458.3, filed to the CNIPA on Mar. 29, 2023. Contents of the above-identified applications should be construed as being incorporated into the present application by reference.

### TECHNICAL FIELD

The present disclosure relates to, but is not limited to, the field of display technologies, and more particularly, to a pixel drive circuit and a drive method thereof, a display substrate, and a display apparatus.

### BACKGROUND

The application of Active Matrix Organic Light Emitting Diode (AMOLED for short) panels is becoming increasingly widespread. A pixel display device of an AMOLED is an Organic Light Emitting Diode (OLED for short). The AMOLED can emit light by driving a thin film transistor to generate a drive current in a saturated state, and the drive current drives a light emitting device to emit light.

### SUMMARY

The present disclosure provides a pixel drive circuit and a drive method thereof, a display substrate, and a display apparatus.

In a first aspect, the present disclosure provides a pixel drive circuit, which includes a current control sub-circuit, the current control sub-circuit includes a drive transistor configured to provide a drive current to a light emitting device according to a voltage between a gate and a first electrode of the drive transistor; and the pixel drive circuit further includes: a voltage control sub-circuit and a time control sub-circuit; the voltage control sub-circuit is configured to transmit a time data signal to the time control sub-circuit in response to a time modulation signal; and the time control sub-circuit is configured to, according to a voltage difference between a modulation voltage signal and a reference signal and a voltage difference between the time data signal and the reference signal, control a gate voltage of the drive transistor to control light emitting time of the light emitting device.

In some embodiments, the time control sub-circuit includes: a first control transistor, which is a double-gate transistor, wherein a first gate of the first control transistor is connected with the voltage control sub-circuit, a second gate of the first control transistor is connected with a modulation voltage line, a first electrode of the first control transistor is connected with the reference signal line, and a second electrode of the first control transistor is connected with the gate of the drive transistor; wherein the modulation voltage line is used to provide the modulation voltage signal and the reference signal line is used to provide the reference signal.

In some embodiments, the voltage control sub-circuit includes: a second control transistor, wherein a gate of the second control transistor is connected with a time modulation line, a first electrode of the second control transistor is connected with a time data line, and a second electrode of the second control transistor is connected with the time control sub-circuit; wherein the time modulation line is used to provide the time modulation signal and the time data line is used to provide the time data signal.

In some embodiments, the voltage control sub-circuit further includes a first capacitor, and both ends of the first capacitor are respectively connected with a first voltage terminal and the second electrode of the second control transistor.

In some embodiments, the modulation voltage signal is a slope voltage signal.

In some embodiments, the current control sub-circuit further includes: a data writing unit, a light emitting control unit, a discharge unit, a first storage unit, and a second storage unit; the data writing unit is configured to write a gray scale data signal to the gate of the drive transistor in response to a scan signal; the light emitting control unit is configured to transmit a signal of a second voltage terminal to the first electrode of the drive transistor in response to a light emitting control signal; the discharge unit is configured to discharge a second electrode of the drive transistor in response to a discharge control signal; the first storage unit is configured to store a voltage between a gate and a first electrode of the drive transistor; and the second storage unit is configured to store a voltage between the first electrode of the drive transistor and the second voltage terminal.

In some embodiments, the data writing unit includes: a data writing transistor, wherein a gate of the data writing transistor is connected with a scan line, a first electrode of the data writing transistor is connected with a gray scale data line, and a second electrode of the data writing transistor is connected with the gate of the drive transistor; wherein the scan line is used to provide the scan signal, and the gray scale data line is used to provide the gray scale data signal.

In some embodiments, the light emitting control unit includes a light emitting control transistor, wherein a gate of the light emitting control transistor is connected with a light emitting control line for providing the light emitting control signal, a first electrode of the light emitting control transistor is connected with the second voltage terminal, and a second electrode of the light emitting control transistor is connected with the first electrode of the drive transistor.

In some embodiments, the discharge unit includes: a discharge transistor, wherein a gate of the discharge transistor is connected with a discharge control line, a first electrode of the discharge transistor is connected with the second electrode of the drive transistor, and a second electrode of the discharge transistor is connected with a first voltage terminal; and the discharge control line is used to provide the discharge control signal.

In some embodiments, the first storage unit includes a second capacitor, and both ends of the second capacitor are respectively connected with the gate and the first electrode of the drive transistor.

In some embodiments, the second storage unit includes a third capacitor, and both ends of the third capacitor are respectively connected with the first electrode of the drive transistor and the second voltage terminal.

In some embodiments, the voltage control sub-circuit includes: a second control transistor and a first capacitor, and both ends of the first capacitor are respectively connected with a first voltage terminal and a second electrode of the second control transistor; the first storage unit includes: a second capacitor, and both ends of the second capacitor are respectively connected with the gate and the first electrode of the drive transistor; wherein a capacitance value of the first capacitor is smaller than a capacitance value of the second capacitor and smaller than a capacitance value of the third capacitor.

In some embodiments, the capacitance value of the second capacitor is equal to the capacitance value of the third capacitor.

In a second aspect, the present disclosure further provides a drive method of the pixel drive circuit described above, including: providing, by a drive transistor of a current control sub-circuit, a drive current to a light emitting device according to a voltage between a gate and a first electrode of the drive transistor; providing, by a voltage control sub-circuit, a time data signal to a time control sub-circuit in response to a time modulation signal; and controlling, by the time control sub-circuit, a gate voltage of the drive transistor according to a voltage difference between a modulation voltage signal and a reference signal and a voltage difference between the time data signal and the reference signal to control light emitting time of the light emitting device.

In a third aspect, the present disclosure further provides a display substrate including a plurality of pixel regions, wherein the pixel regions are provided with a light emitting device and a pixel drive circuit electrically connected with the light emitting device, and the pixel drive circuit is the pixel drive circuit described above.

In a fourth aspect, the present disclosure further provides a display apparatus including the display substrate described above.

### BRIEF DESCRIPTION OF DRAWINGS

The drawings are used for providing a further understanding of the present disclosure and constitute a part of the specification, and are used for explaining the present disclosure together with the following specific implementation modes but do not constitute limitations on the present disclosure. In the drawings.

FIG. 1 is a diagram of a curve of a relationship between a current and a peak wavelength of an OLED device.

FIG. 2 is a schematic diagram of a curve of a relationship between a current density and a wavelength of an OLED device.

FIG. 3 is a schematic diagram of a pixel drive circuit according to some embodiments of the present disclosure.

FIG. 4 is a schematic diagram of a pixel drive circuit according to other embodiments of the present disclosure.

FIG. 5 is a diagram of a curve of a relationship between a positive gate-source voltage difference of a double-gate transistor and a leakage current.

FIG. 6 is a diagram of a curve of a relationship between a threshold voltage and a back gate-source voltage difference of a double-gate transistor.

FIG. 7 is a timing diagram of a pixel drive circuit according to some embodiments of the present disclosure.

FIG. 8 is a schematic diagram of a drive method of a pixel drive circuit according to some embodiments of the present disclosure.

### DETAILED DESCRIPTION

Specific implementation modes of the present disclosure are described in detail below with reference to the accompanying drawings. It should be understood that the specific implementation modes described herein are only intended to illustrate and explain the present disclosure and are not intended to limit the present disclosure.

In order to make objectives, technical solutions, and advantages of the embodiments of the present disclosure more clear, the technical solutions of the embodiments of the present disclosure will be clearly and completely described below with reference to the drawings of the embodiments of the present disclosure. Apparently, the described embodiments are a part of the embodiments of the present disclosure, not all of the embodiments. Based on the described embodiments of the present disclosure, all other embodiments obtained by those of ordinary skills in the art without paying any inventive effort belong to the protection scope of the present disclosure.

Unless otherwise defined, technical terms or scientific terms used in the embodiments of the present disclosure shall have common meanings understood by those with ordinary skills in the art to which the present disclosure pertains. Terms “first”, “second”, and similar terms used in the present disclosure do not indicate any order, quantity, or importance, but are used only for distinguishing different components. Likewise, wording such as “include”, “contain”, and the like mean that elements or objects appearing before the wording cover elements or objects listed after the wording and their equivalents, but do not exclude other elements or objects. “Connect”, “couple”, or similar words are not limited to a physical or mechanical connection, but may include an electrical connection, whether direct or indirect.

Each transistor involved in the embodiments of the present disclosure may be independently selected from one of a polycrystalline silicon thin film transistor, an amorphous silicon thin film transistor, an oxide thin film transistor, and an organic thin film transistor. A “first electrode” involved in the present disclosure specifically refers to a source electrode of a transistor, and a corresponding “second electrode” specifically refers to a drain electrode of the transistor. Of course, those skilled in the art should know that the “first electrode” and “second electrode” are interchangeable.

In addition, a working level state refers to a level state in which the first electrode and the second electrode of the transistor can be turned on, and a non-working level state refers to a level state in which the first electrode and the second electrode of the transistor can be turned off. Transistors may be divided into N-type transistors and P-type transistors, and each transistor in the present disclosure may be independently selected from an N-type transistor or a P-type transistor, respectively; for an N-type transistor, the working level state is a high-level state and the non-working level state is a low-level state; and for a P-type transistor, the working level state is a low-level state, and the non-working level state is a high-level state. In embodiments described below, exemplary description is made by taking a case that all transistors in a pixel unit are N-type transistors as an example, and at this time, the transistors in a pixel drive circuit may be simultaneously prepared through a same preparation process.

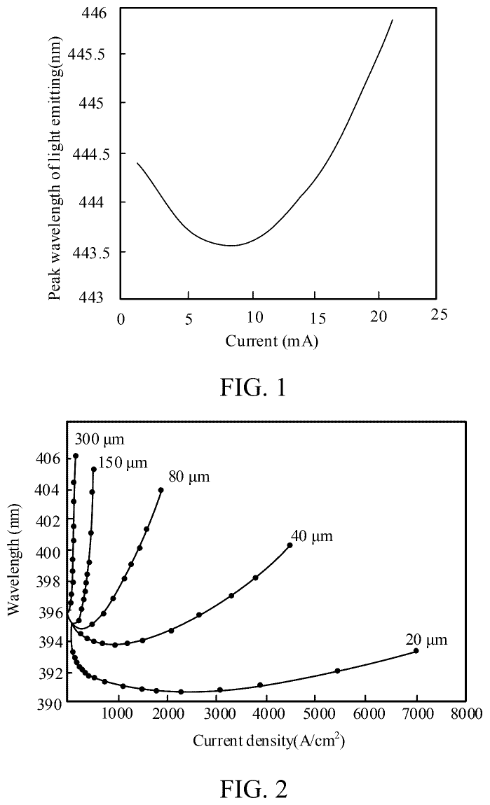

The display substrate includes a display region and a peripheral region located around the display region, and the display region includes a plurality of pixel regions, each of which is provided with a light emitting device and a pixel drive circuit for providing a drive signal to the light emitting device. Herein, the light emitting device may be an OLED device. FIG. 1 is a diagram of a curve of a relationship between a current and a peak wavelength of an OLED device. It may be seen from FIG. 1 that the peak wavelength of light emitting of the OLED device shows a U-shaped growth under different currents. FIG. 2 is a schematic diagram of a curve of a relationship between a current density and a wavelength of an OLED device. It may be seen from FIG. 2 that under a same condition, the smaller the current density through the OLED device, the greater the shift of its spectral wavelength, and the more serious the problem of color shift becomes. Therefore, for a display substrate, when the display substrate displays an image with low gray scale, a problem of color shift is likely to occur.

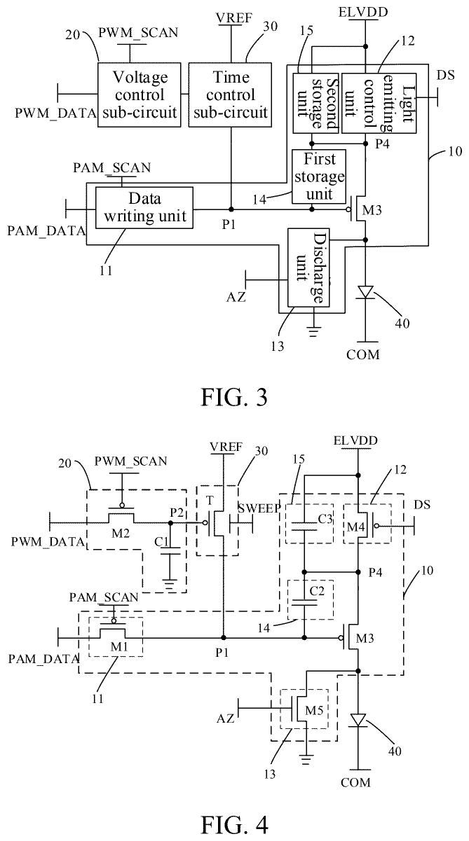

FIG. 3 is a schematic diagram of a pixel drive circuit according to some embodiments of the present disclosure. As shown in FIG. 3, the pixel drive circuit includes a current control sub-circuit 10, a voltage control sub-circuit 20, and a time control sub-circuit 30.

Herein, the current control sub-circuit 10 is connected with a first electrode of a light emitting device 40, and a second electrode of the light emitting device 40 is connected with a common voltage terminal COM. The first electrode of the light emitting device 40 may be an anode, and the second electrode may be a cathode. The current control sub-circuit 10 includes a drive transistor M3, which is configured to provide a drive current to the light emitting device 40 according to a voltage between a gate and the first electrode thereof.

The voltage control sub-circuit 20 is configured to transmit a time data signal to the time control sub-circuit 30 in response to a time modulation signal.

The time control sub-circuit 30 is configured to control a gate voltage of the drive transistor M3 according to a voltage difference between a modulation voltage signal and a reference signal and a voltage difference between a time data signal and the reference signal to control the drive transistor M3 to be turned on and turned off, thereby controlling light emitting time of the light emitting device 40. Herein, the reference signal may be a signal with a fixed voltage; and the modulation voltage signal is a signal with an adjustable voltage.

In the pixel drive circuit provided by the embodiment of the present disclosure, in a light emitting stage, the current control sub-circuit 10 provides a drive current to the light emitting device 40 according to a voltage between the gate and the first electrode thereof; and moreover, the current control sub-circuit 10 may control the voltage difference between the modulation voltage signal and the reference signal, such that the time control sub-circuit 30 controls the gate voltage of the drive transistor M3, thereby controlling the drive transistor M3 to be turned on and turned off and further controlling the light emitting time of the light emitting device 40 to achieve each gray scale display. Herein, when achieving high gray scale display, the light emitting time may be controlled to be longer; and when achieving low gray scale display, the light emitting time may be controlled to be shorter, thus solving a problem of color shift caused by a too low current density at low gray scale.

FIG. 4 is a schematic diagram of a pixel drive circuit according to other embodiments of the present disclosure, and FIG. 4 is a specific implementation scheme of FIG. 3. As shown in FIG. 4, the time control sub-circuit 30 includes a first control transistor T, which is a double-gate transistor, wherein a first gate of the first control transistor T is connected with the voltage control sub-circuit 20, a second gate of the first control transistor T is connected with a modulation voltage line SWEEP, a first electrode of the first control transistor T is connected with a reference signal line VREF for providing a reference signal, and a second electrode of the first control transistor T is connected with a gate of the drive transistor M3. Herein, the modulation voltage line SWEEP is used to provide the modulation voltage signal described above, and the reference signal line VREF is used to provide the reference signal described above.

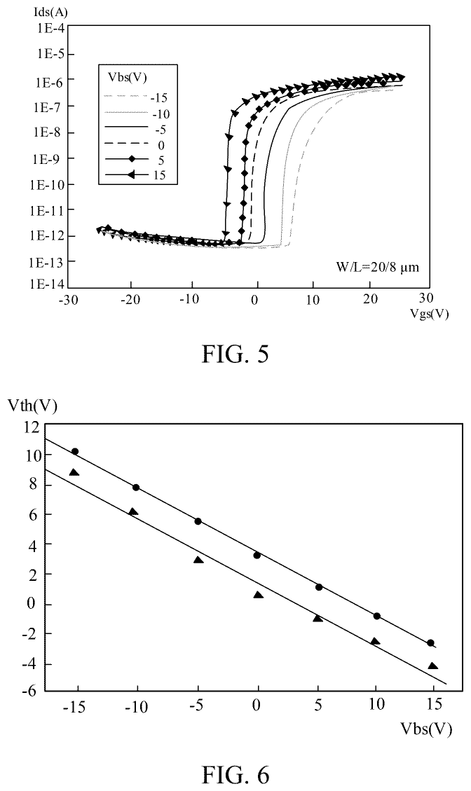

Herein, the first gate of the double-gate transistor is a positive gate and the second gate of the double-gate transistor is a back gate. FIG. 5 is a diagram of a curve of a relationship between a positive gate-source voltage difference of a double-gate transistor and a leakage current, and FIG. 6 is a diagram of a curve of a relationship between a threshold voltage and a back gate-source voltage difference of a double-gate transistor, wherein the positive gate-source voltage difference is a voltage difference Vgs between the first gate and a source of the double-gate transistor, and the back gate-source voltage difference is a voltage difference Vbs between the second gate and the source of the double-gate transistor. As may be seen from FIGS. 5 and 6, a threshold voltage Vth of the double-gate transistor gradually decreases with increase of the back gate-source voltage difference.

Herein, the modulation voltage signal may be a slope voltage signal. The slope voltage signal refers to a signal that a voltage value may be incremented or decremented according to a required slope in a certain period of time.

Herein, a voltage of the reference signal satisfies that when the gate of the drive transistor M3 receives the reference signal and the first electrode receives a voltage signal of a second voltage terminal ELVDD, the drive transistor M3 is turned off. Taking a case that the drive transistor M3 is a P-type transistor as an example, a difference between the reference signal and the voltage signal of the second voltage terminal ELVDD is larger than a threshold voltage of the drive transistor M3.

In the embodiment of the present disclosure, the second gate of the first control transistor T (double-gate transistor) is connected with the slope voltage signal, so when the drive transistor T3 needs to be turned off in the light emitting stage, a voltage on a slope voltage line SWEEP may be reduced, thereby increasing a threshold voltage of the double-gate transistor, which thus makes the double-gate transistor turned on, such that the reference signal is transmitted to the gate of the drive transistor M3 to control the drive transistor M3 to be turned off. That is to say, by controlling a slope of the slope voltage signal, light emitting time of the light emitting device 40 may be controlled.

As shown in FIG. 4, the voltage control sub-circuit 20 may include a second control transistor M2, wherein a gate of the second control transistor M2 is connected with a time modulation line PWM_SCAN, a first electrode of the second control transistor M2 is connected with a time data line PWM_DATA for providing a time data signal, and a second electrode of the second control transistor M2 is connected with the time control sub-circuit 30. Herein, the time modulation line PWM_SCAN is used to provide a time modulation signal, and the time data line PWM_DATA is used to provide a time data signal. When the time modulation signal is in an active level state, the second control transistor M2 is turned on, thereby the time data signal is transmitted to the first gate of the first control transistor T.

Further, the voltage control sub-circuit 20 may further include a first capacitor C1, and both ends of the first capacitor C1 are respectively connected with a first voltage terminal V1 and the second electrode of the second control transistor M2. Herein, the first voltage terminal V1 may be a ground terminal. The first capacitor C1 may store a voltage of the time data signal, so that it is not necessary to provide the time data signal to the pixel drive circuit for a long time, thus reducing drive power consumption.

As shown in FIG. 4, the current control sub-circuit 10 includes a data writing unit 11, a light emitting control unit 12, a discharge unit 13, a first storage unit 14, and a second storage unit 15 in addition to the drive transistor M3.

The data writing unit 11 is connected with a scan line PAM_SCAN, a gray scale data line PAM_DATA and the gate of the drive transistor M3, wherein the scan line PAM_SCAN is used to provide a scan signal, and the gray scale data line PAM_DATA is used to provide a gray scale data signal. The data writing unit 11 is configured to write the gray scale data signal to the gate of the drive transistor M3 in response to the scan signal.

Herein, the data writing unit 11 may include a data writing transistor M1, wherein a gate of the data writing transistor M1 is connected with the scan line PAM_SCAN, a first electrode of the data writing transistor M1 is connected with the gray scale data line PAM_DATA, and a second electrode of the data writing transistor M1 is connected with the gate of the drive transistor M3. When a scan signal on the scan line PAM_SCAN is in an active level state, the first electrode and the second electrode of the data writing transistor M1 are turned on.

The light emitting control unit 12 is connected with a second voltage terminal ELVDD, a light emitting control line DS, and the first electrode of the drive transistor M3, and the light emitting control line DS is used to provide a light emitting control signal. The light emitting control unit 12 is configured to transmit a signal of the second voltage terminal ELVDD to the first electrode of the drive transistor M3 in response to the light emitting control signal.

Herein, the light emitting control unit 12 may include a light emitting control transistor M4, wherein a gate of the light emitting control transistor M4 is connected with the light emitting control line DS, a first electrode of the light emitting control transistor M4 is connected with the second voltage terminal ELVDD, and a second electrode of the light emitting control transistor M4 is connected with the first electrode of the drive transistor M3. When the light emitting control signal is in a working level state, the first electrode and the second electrode of the light emitting control transistor M4 are turned on, thereby a signal of the second voltage terminal ELVDD is transmitted to the first electrode of the drive transistor M3.

The discharge unit 13 is connected with a discharge control line AZ and the second electrode of the drive transistor M3, and the discharge control line AZ is used to provide a discharge control signal. The discharge unit 13 is configured to discharge the second electrode of the drive transistor M3 in response to the discharge control signal.

Herein, the discharge unit 13 includes a discharge transistor M5, wherein a gate of the discharge transistor M5 is connected with the discharge control line AZ, a first electrode of the discharge transistor M5 is connected with the second electrode of the drive transistor M3, and a second electrode of the discharge transistor M5 is connected with the first voltage terminal V1.

The first storage unit 14 is connected between the gate and the first electrode of the drive transistor M3, and is used to store a voltage between the gate and the first electrode of the drive transistor M3. The second storage unit 15 is connected between the first electrode of the drive transistor M3 and the second voltage terminal ELVDD, and is used to store a voltage between the first electrode of the drive transistor M3 and the second voltage terminal ELVDD.

Herein, the first storage unit 14 includes a second capacitor C2, and both ends of the second capacitor C2 are respectively connected with the gate and the first electrode of the drive transistor M3. The second storage unit 15 includes a third capacitor C3, and both ends of the third capacitor C3 are respectively connected with the first electrode of the drive transistor M3 and the second voltage terminal ELVDD.

In some embodiments, a capacitance value of the first capacitor C1 is less than a capacitance value of the second capacitor C2, and the capacitance value of the first capacitor C1 is less than a capacitance value of the third capacitor C3. Setting the capacitance value of the first capacitor C1 to be relatively small is beneficial to reducing a leakage current of the first control transistor T.

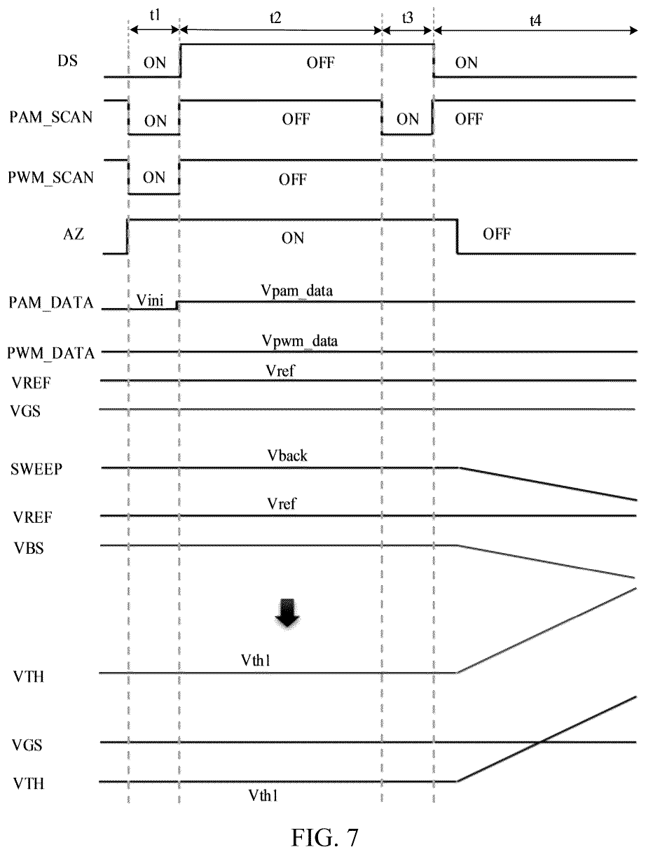

In the following, a working process of the pixel drive circuit will be described by taking a case that the first control transistor T, the second control transistor M2, the data writing transistor M1, the drive transistor M3, and the light emitting control transistor M4 are all P-type transistors, and the discharge transistor M5 is an N-type transistor as an example. Herein, FIG. 7 is a timing diagram of a pixel drive circuit according to some embodiments of the present disclosure, wherein a voltage of a reference signal on the reference signal line VREF is Vref, and a voltage of a time data signal on the time data line PWM_DATA is Vpwm_data. A voltage of the second voltage terminal ELVDD is denoted as Vdd. “ON” in FIG. 7 indicates that a signal is in a working level state, and “OFF” indicates that a signal is in a non-working level state.

As shown in FIG. 7, the working process of the pixel drive circuit includes an initialization stage t1, a self-discharge stage t2, a data writing stage t3, and a light emitting stage t4.

In the initialization stage t1, a light emitting control signal on the light emitting control line DS, a scan signal on the scan line PAM_SCAN, a time modulation signal on the time modulation line PWM_SCAN, and a discharge control signal on the discharge control line AZ are all in a working level state; and a voltage value of a gray scale data signal on the gray scale data line PAM_DATA is Vini, wherein Vini-Vdd is smaller than a threshold voltage of the drive transistor M3. At this time, the light emitting control transistor M4, the data writing transistor M1, the second control transistor M2, and the discharge transistor M5 are all turned on, a potential of a P1 node (i.e., a connection node between the drive transistor M3, and the data writing transistor M1 and the first control transistor T) is Vini, and a potential of a P4 node (i.e., a connection node between the drive transistor M3, the light emitting control transistor M4, the second capacitor C2, and the third capacitor C3) is Vdd. A potential of a P2 node (i.e., a connection node between the first capacitor C1, the first control transistor T, and the second control transistor M2) is Vpwm_data, and the potential of the P2 node is maintained by the first capacitor C1.

Herein, a threshold voltage of the first control transistor T is denoted by VTH, a potential of the second gate of the first control transistor T is Vback, and a specific value of a corresponding threshold voltage at this time is denoted by Vth1. A potential of the first electrode of the first control transistor T is Vref, and by setting a value of Vpwm_data, Vpwm_data-Vref>Vth1, and the first control transistor T is turned off. A gate-source voltage differential Vini-Vdd of the drive transistor M3 is smaller than a threshold voltage of the drive transistor M3, such that the drive transistor M3 is turned on.

In the self-discharge stage t2, a light emitting control signal on the light emitting control line DS, a scan signal on the scan line PAM_SCAN, and a time modulation signal on the time modulation line PWM_SCAN are all in a non-working level state, and a discharge control signal on the discharge control line AZ is in a working level state. At this time, the light emitting control transistor M4, the data writing transistor M1, and the second control transistor M2 are all turned off. Potentials of the first gate, the second gate, and the first electrode of the first control transistor T are all kept the same as those of the previous stage, and thus, the first control transistor T remains in a turned-off state. Further, the discharge transistor M5 and the drive transistor M3 remains in a turned-on state of the previous stage, such that the potential of the P4 node is pulled down until a voltage difference between the P3 node and the P4 node reaches a threshold voltage Vth3 of the drive transistor M3, and the drive transistor M3 is shifted from a turned-on state to a turned-off state. At this time, the potential of the P4 node is Vini-Vth3; and at this time, the threshold voltage Vth3 of the drive transistor M3 is stored in the second capacitor C2.

In the data writing stage t3, the light emitting control signal on the light emitting control line DS and the time modulation signal on the time modulation line PWM_SCAN are both in a non-working state, such that the light emitting control transistor M4 and the second control transistor M2 are turned off. A voltage of a data signal on the gray scale data line PAM_DATA is Vpam_data, and a discharge control signal on the discharge control line AZ, and a scan signal on the scan line PAM_SCAN are both in a working level state, such that both the discharge transistor M5 and the data writing transistor M1 are turned on, and the potential of the P1 node is changed from Vini to Vpam_data. Under a bootstrap action of the second capacitor C2 and the third capacitor C3, the potential V4 of the P4 node is represented by a following formula.

$$V 4 = \frac{C 2}{C 2 + C 3} \times ( Vpam\_data - Vini ) + Vini - Vth 3$$

In the light emitting stage t4, a light emitting control signal on the light emitting control line DS is in a working level state, and a scan signal on the scan line PAM_SCAN and a discharge signal on the discharge control line AZ are both in a non-working level state. At this time, the light emitting control transistor M4 is turned on, the data writing transistor M1, the discharge transistor M5, and the second control transistor M2 are all turned off, and the gate-source voltage difference of the drive transistor M3 is less than the threshold voltage of the drive transistor M3, such that the drive transistor M3 is turned on, thereby providing a drive current to the light emitting device 40. Herein, the drive current Ioled is represented by a following formula.

$$\begin{matrix}Ioled = β {( Vgs 3 - Vth 3 )}^{2} \\ = β {( Vpam\_data - V 4 - Vth 3 )}^{2} \\ = {β [ Vpam\_data - \frac{C 2}{C 2 + C 3} \times ( Vpam\_data - Vini ) - Vini ]}^{2}\end{matrix}$$

Herein,

$$β = \frac{1}{2} {μ}_{n} {C}_{ox} ( \frac{W}{L} ) ,$$

μₙ is an electron mobility of the drive transistor M3, Cₒₓ is an insulation capacitance per unit area, W/L is a width-length ratio of the drive transistor M3.

Herein, the drive current Ioled described above is a current corresponding to a voltage value of the modulation voltage signal when the voltage value of the modulation voltage signal is Vback. When a voltage of the modulation voltage signal gradually decreases, a back gate-source voltage difference VBS of the first control transistor T gradually decreases, such that a threshold voltage VTH of the first control transistor T gradually increases until a positive gate-source voltage difference VGS of the first control transistor T is less than the threshold voltage VTH of the first control transistor T. At this time, the first control transistor T is shifted from a turned-off state to a turned-on state, such that the potential of the P1 node reaches Vref. At this time, a gate-source voltage of the drive transistor M3 is larger than a threshold voltage of the drive transistor M 3, such that the drive transistor M 3 is turned off, and the light emitting device 40 stops emitting light.

As may be seen from the above process, in the light emitting stage, by adjusting a voltage of the modulation voltage signal, light emitting time of the light emitting device 40 may be indirectly controlled, such that brightness of the light emitting device 40 may be controlled, and a magnitude of the drive current is independent of the threshold voltage of the drive transistor M3. Therefore, when high gray scale display is performed, luminous brightness of the light emitting device 40 may be controlled by adjusting a voltage of a gray scale data signal in the data writing stage; and when low gray scale display is performed, brightness of the light emitting device 40 is controlled by controlling the light emitting time of the light emitting device 40, so that the problem of color shift caused by the too low current density at low gray scale may be solved. Moreover, a structure of the pixel drive circuit in the embodiment of the present disclosure is relatively simple and easy to implement.

In some embodiments, capacitance values of the second capacitor C2 and the third capacitor C3 may be equal, so that a threshold compensation effect may be improved.

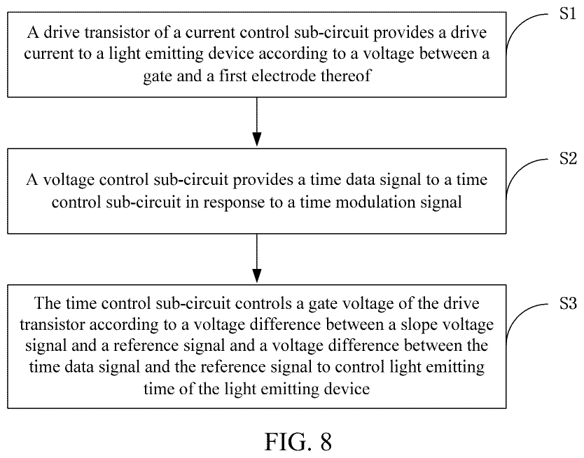

FIG. 8 is a schematic diagram of a drive method of a pixel drive circuit according to some embodiments of the present disclosure, and as shown in FIG. 8, the drive method of the pixel drive circuit includes following acts.

In act S1, a drive transistor of a current control sub-circuit provides a drive current to a light emitting device according to a voltage between a gate and a first electrode thereof.

In act S2, a voltage control sub-circuit provides a time data signal to a time control sub-circuit in response to a time modulation signal.

In act S3, the time control sub-circuit controls a gate voltage of the drive transistor according to a voltage difference between a modulation voltage signal and a reference signal and a voltage difference between the time data signal and the reference signal to control light emitting time of the light emitting device.

Herein, a specific working process of the pixel drive circuit has been described above, and will not be repeated here.

An embodiment of the present disclosure also provides a display substrate including a display region. The display region is provided with a plurality of gate lines and a plurality of data lines, and the plurality of gate lines and the plurality of data lines are disposed in a cross way so that the display region is divided into a plurality of pixel regions, each of which is provided with a light emitting device and a pixel drive circuit connected with the light emitting device, and the pixel drive circuit is the pixel drive circuit provided in the above embodiment.

An embodiment of the present disclosure also provides a display apparatus, including the display substrate described above. The display apparatus may include any device or product having a display function. For example, the display apparatus may be a smartphone, a mobile phone, an electronic book reader, a desktop computer (PC), a laptop PC, a netbook PC, a Personal Digital Assistant (PDA), a Portable Multimedia Player (PMP), a digital audio player, a mobile medical device, a camera, a wearable device (e.g., a head-mounted device, an electronic clothing, an electronic bracelet, an electronic accessory, an electronic tattoo, or a smart watch), a television, or the like.

It may be understood that the above implementation modes are only exemplary implementation modes adopted for illustrating principles of the present disclosure, however the present disclosure is not limited thereto. For those of ordinary skills in the art, various variations and improvements may be made without departing from the spirit and essence of the present disclosure, and these variations and improvements are also regarded as the protection scope of the present disclosure.

1. A pixel drive circuit, comprising: a current control sub-circuit, wherein the current control sub-circuit comprises a drive transistor, the drive transistor is configured to provide a drive current to a light emitting device according to a voltage between a gate and a first electrode of the drive transistor; and the pixel drive circuit further comprises: a voltage control sub-circuit and a time control sub-circuit;
the voltage control sub-circuit is configured to transmit a time data signal to the time control sub-circuit in response to a time modulation signal; and
the time control sub-circuit is configured to, according to a voltage difference between a modulation voltage signal and a reference signal and a voltage difference between the time data signal and the reference signal, control a gate voltage of the drive transistor to control light emitting time of the light emitting device.

2. The pixel drive circuit according to claim 1, wherein the time control sub-circuit comprises: a first control transistor, which is a double-gate transistor; a first gate of the first control transistor is connected with the voltage control sub-circuit, a second gate of the first control transistor is connected with a modulation voltage line, a first electrode of the first control transistor is connected with a reference signal line, and a second electrode of the first control transistor is connected with the gate of the drive transistor;
wherein the modulation voltage line is used to provide the modulation voltage signal and the reference signal line is used to provide the reference signal.

3. The pixel drive circuit according to claim 1, wherein the voltage control sub-circuit comprises: a second control transistor; a gate of the second control transistor is connected with a time modulation line, a first electrode of the second control transistor is connected with a time data line, and a second electrode of the second control transistor is connected with the time control sub-circuit;
wherein the time modulation line is used to provide the time modulation signal and the time data line is used to provide the time data signal.

4. The pixel drive circuit according to claim 3, wherein the voltage control sub-circuit further comprises a first capacitor, and both ends of the first capacitor are respectively connected with a first voltage terminal and the second electrode of the second control transistor.

5. The pixel drive circuit according to claim 1, wherein the modulation voltage signal is a slope voltage signal.

6. The pixel drive circuit according to claim 1, wherein the current control sub-circuit further comprises: a data writing unit, a light emitting control unit, a discharge unit, a first storage unit, and a second storage unit;
the data writing unit is configured to write a gray scale data signal to the gate of the drive transistor in response to a scan signal;
the light emitting control unit is configured to transmit a signal of a second voltage terminal to the first electrode of the drive transistor in response to a light emitting control signal;
the discharge unit is configured to discharge a second electrode of the drive transistor in response to a discharge control signal;
the first storage unit is configured to store a voltage between the gate and the first electrode of the drive transistor; and
the second storage unit is configured to store a voltage between the first electrode of the drive transistor and the second voltage terminal.

7. The pixel drive circuit according to claim 6, wherein the data writing unit comprises: a data writing transistor; a gate of the data writing transistor is connected with a scan line, a first electrode of the data writing transistor is connected with a gray scale data line, and a second electrode of the data writing transistor is connected with the gate of the drive transistor
wherein the scan line is used to provide the scan signal, and the gray scale data line is used to provide the gray scale data signal.

8. The pixel drive circuit according to claim 6, wherein the light emitting control unit comprises a light emitting control transistor, a gate of the light emitting control transistor is connected with a light emitting control line for providing the light emitting control signal, a first electrode of the light emitting control transistor is connected with the second voltage terminal, and a second electrode of the light emitting control transistor is connected with the first electrode of the drive transistor.

9. The pixel drive circuit according to claim 6, wherein the discharge unit comprises: a discharge transistor; a gate of the discharge transistor is connected with a discharge control line, a first electrode of the discharge transistor is connected with the second electrode of the drive transistor, and a second electrode of the discharge transistor is connected with a first voltage terminal; and the discharge control line is used to provide the discharge control signal.

10. The pixel drive circuit according to claim 6, wherein the first storage unit comprises: a second capacitor, and both ends of the second capacitor are respectively connected with the gate and the first electrode of the drive transistor.

11. The pixel drive circuit according to claim 6, wherein the second storage unit comprises: a third capacitor, and both ends of the third capacitor are respectively connected with the first electrode of the drive transistor and the second voltage terminal.

12. The pixel drive circuit according to claim 11, wherein the voltage control sub-circuit comprises a second control transistor and a first capacitor, and both ends of the first capacitor are respectively connected with a first voltage terminal and a second electrode of the second control transistor;
the first storage unit comprises: a second capacitor, and both ends of the second capacitor are respectively connected with the gate and the first electrode of the drive transistor;
wherein a capacitance value of the first capacitor is smaller than a capacitance value of the second capacitor and smaller than a capacitance value of the third capacitor.

13. The pixel drive circuit according to claim 12, wherein the capacitance value of the second capacitor is equal to the capacitance value of the third capacitor.

14. A drive method of the pixel drive circuit according to claim 1, comprising:
providing, by a drive transistor of a current control sub-circuit, a drive current to a light emitting device according to a voltage between a gate and a first electrode of the drive transistor;
providing, by a voltage control sub-circuit, a time data signal to a time control sub-circuit in response to a time modulation signal; and
controlling, by the time control sub-circuit, a gate voltage of the drive transistor according to a voltage difference between a modulation voltage signal and a reference signal and a voltage difference between the time data signal and the reference signal to control light emitting time of the light emitting device.

15. A display substrate, comprising a plurality of pixel regions, wherein the pixel regions are provided with a light emitting device and a pixel drive circuit electrically connected with the light emitting device, and the pixel drive circuit is a pixel drive circuit according to claim 1.

16. A display apparatus, comprising a display substrate according to claim 15.

17. The pixel drive circuit according to claim 2, wherein the modulation voltage signal is a slope voltage signal.

18. The pixel drive circuit according to claim 3, wherein the modulation voltage signal is a slope voltage signal.

19. The pixel drive circuit according to claim 2, wherein the current control sub-circuit further comprises: a data writing unit, a light emitting control unit, a discharge unit, a first storage unit, and a second storage unit;
the data writing unit is configured to write a gray scale data signal to the gate of the drive transistor in response to a scan signal;
the light emitting control unit is configured to transmit a signal of a second voltage terminal to the first electrode of the drive transistor in response to a light emitting control signal;
the discharge unit is configured to discharge a second electrode of the drive transistor in response to a discharge control signal;
the first storage unit is configured to store a voltage between the gate and the first electrode of the drive transistor; and
the second storage unit is configured to store a voltage between the first electrode of the drive transistor and the second voltage terminal.

20. The pixel drive circuit according to claim 3, wherein the current control sub-circuit further comprises: a data writing unit, a light emitting control unit, a discharge unit, a first storage unit, and a second storage unit;
the data writing unit is configured to write a gray scale data signal to the gate of the drive transistor in response to a scan signal;
the light emitting control unit is configured to transmit a signal of a second voltage terminal to the first electrode of the drive transistor in response to a light emitting control signal;
the discharge unit is configured to discharge a second electrode of the drive transistor in response to a discharge control signal;
the first storage unit is configured to store a voltage between the gate and the first electrode of the drive transistor; and
the second storage unit is configured to store a voltage between the first electrode of the drive transistor and the second voltage terminal.
